(19) United States
(12) Patent Application Publication
(10) Pub. No.: US 2023/0094059 A1
(43) Pub. Date: Mar. 30, 2023

(54) TRANSFER APPARATUS, DATA PROCESSING METHOD AND PROGRAM

(71) Applicant: NIPPON TELEGRAPH AND TELEPHONE CORPORATION, Tokyo (JP)

(72) Inventors: Katsuma MIYAMOTO, Musashino-shi, Tokyo (JP); Akihiro KIMURA, Musashino-shi, Tokyo (JP); Hiroki KANO, Musashino-shi, Tokyo (JP)

(21) Appl. No.: 17/758,725

(22) PCT Filed: Jan. 28, 2020
(86) PCT No.: PCT/JP2020/003039

§ 371 Date: Jul. 13, 2022

(51) Int. Cl. H04L 45/74; H04L 67/50

(52) U.S. Cl. CPC H04L 45/74; H04L 67/50

(57) ABSTRACT

A transfer device is provided on a service provider network different from a carrier network, and includes: an identifier inquiry unit configured to acquire a user identifier from an intra-carrier-network database storing an IP address and the user identifier using a transmission source IP address of a packet received from a user terminal to which the IP address is allocated from the carrier network; and a data processing unit configured to execute processing to the packet according to the user identifier.

### TECHNICAL FIELD

The present invention relates to a technology of acquiring a user identifier in a communication system.

### BACKGROUND ART

As disclosed in Non-Patent Literature 1 for example, a service of executing high load processing such as encryption and transfer processing relating to an IoT device on a cloud has been provided.

In such a service, communication of an IoT device incapable of encryption processing due to CPU or power limitation can be encrypted (HTTP→HTTPS or the like), and troublesome processing such as management of a certificate and coping with vulnerability can be offloaded to a cloud. Thus, a user can easily utilize encrypted communication.

In addition, packets can be distributed to various kinds of servers for each user while fixing a transmission destination end point of the IoT device by transfer processing. That is, a different service can be provided for each user.

### CITATION LIST

### Non-Patent Literature

Non-Patent Literature 1: SORACOM “SORACOM Beam” https://soracom.jp/services/beam/

Non-Patent Literature 2: ITmedia@IT “Unknown LTE network configuration” https://www.atmarkit.co.jp/ait/articles/1001/13/news105_2.html

### SUMMARY OF THE INVENTION

### Technical Problem

In order to provide a different service for each user, a transfer device which provides a transfer function needs to be able to identify the user. Therefore, it is conceivable that the transfer device is deployed on a network (a substantial carrier network) closely coupled with a carrier network so as to easily identify the user from a customer database held by a carrier or the like.

However, it is sometimes not easy to deploy a transfer device on a network closely coupled with a carrier network and provide services depending on a service provider from a viewpoint of profitability and operations or the like.

That is, depending on the service provider, there is a case where it is desired to deploy the transfer device on a network (service provider network or the like) different from the carrier network and provide a different service for each user. However, in a form that the transfer device is deployed on the network different from the carrier network, the user cannot be identified from a packet received by the transfer device so that the different service cannot be provided for each user.

The present invention is implemented in consideration of the point described above, and an object is to provide a technology which enables a transfer device provided on a service provider network different from a carrier network to provide a different service for each user.

### Means for Solving the Problem

According to a disclosed technology, a transfer device is provided on a service provider network different from a carrier network, and the transfer device includes:

an identifier inquiry unit configured to acquire a user identifier from an intra-carrier-network database storing an IP address and the user identifier using a transmission source IP address of a packet received from a user terminal to which the IP address is allocated from the carrier network; and

a data processing unit configured to execute processing to the packet according to the user identifier.

### Effects of the Invention

According to the disclosed technology, a different service can be provided for each user by the transfer device provided on the service provider network different from the carrier network.

### BRIEF DESCRIPTION OF DRAWINGS

FIG. 1 is a diagram for describing a related technology.

FIG. 2 is a diagram for describing a problem.

FIG. 3 is a system configuration diagram in an embodiment of the present invention.

FIG. 4 is a functional configuration diagram of a transfer device.

FIG. 5 is a functional configuration diagram of an identifier acquisition I/F device.

FIG. 6 is a diagram illustrating a hardware configuration example of a device.

FIG. 7 is a sequence diagram illustrating an operation of a system.

### DESCRIPTION OF EMBODIMENTS

Hereinafter, the embodiment of the present invention (the present embodiment) will be described with reference to the drawings. The embodiment described below is just an example, and the embodiment to which the present invention is applied is not limited to the embodiment below.

(Description of Related Technology)

Before describing a technology relating to the present embodiment, the related technology will be described first. The related technology is a form of deploying a transfer device on a network closely coupled with a carrier network.

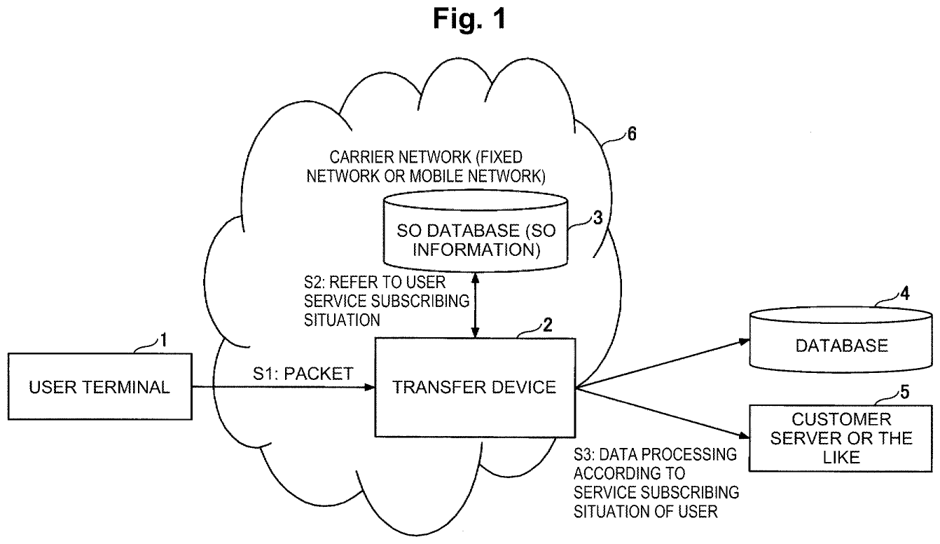

FIG. 1 illustrates a system configuration example relating to the related technology. A present communication system is a system which provides an IoT service as described in the technical field. As illustrated in FIG. 1, on a carrier network 6 (such as a fixed network or a mobile network), a transfer device 2 (including a data processing function of encryption or the like) for service provision is provided. In an SO (Service Order) database 3, a user identifier and information of a service that a user subscribes to or the like are stored for each user.

A packet is transmitted from a user terminal 1 in S1, and the transfer device 2 receives the packet. In the carrier network 6, the packet is transferred by a tunneling protocol such as GTP-U of LTE so that the transfer device 2 can specify the user identifier by header information of the received packet.

In S2, the transfer device 2 acquires the information of a service subscribing situation of the user from the SO database 3 using the user identifier. In S3, the transfer device 2 executes data processing according to the service subscribing situation of the user. Note that the processing (such as encryption or transfer) to the received packet is generically referred to as the data processing.

In the related technology, it is a premise that the transfer device 2 can identify the user from the received packet. Accordingly, as illustrated in FIG. 1, the transfer device 2 is deployed in a network closely coupled with the carrier network 6. However, as previously described, it is sometimes desirable to deploy the transfer device 2 on a network different from the carrier network 6 depending on a service provider.

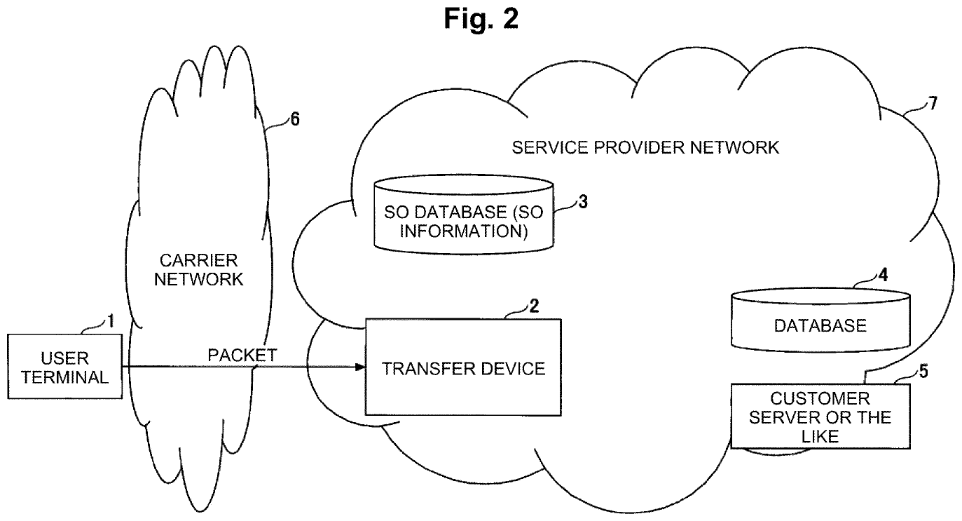

FIG. 2 illustrates a configuration example of the system in a case of deploying the transfer device 2 on a service provider network 7 which is a network different from the carrier network 6.

In the configuration in FIG. 2, a tunnel of the GTP-U or the like is terminated inside the carrier network 6. Therefore, even when the transfer device 2 receives the packet transmitted from the user terminal 1, the user cannot be identified from the packet. Thus, the transfer device 2 cannot acquire the service subscribing situation of the user from the SO database 3, and cannot provide a different service for each user.

Hereinafter, as a technology for solving the problem described above, the system relating to the present embodiment will be described.

(About System Relating to Present Embodiment)

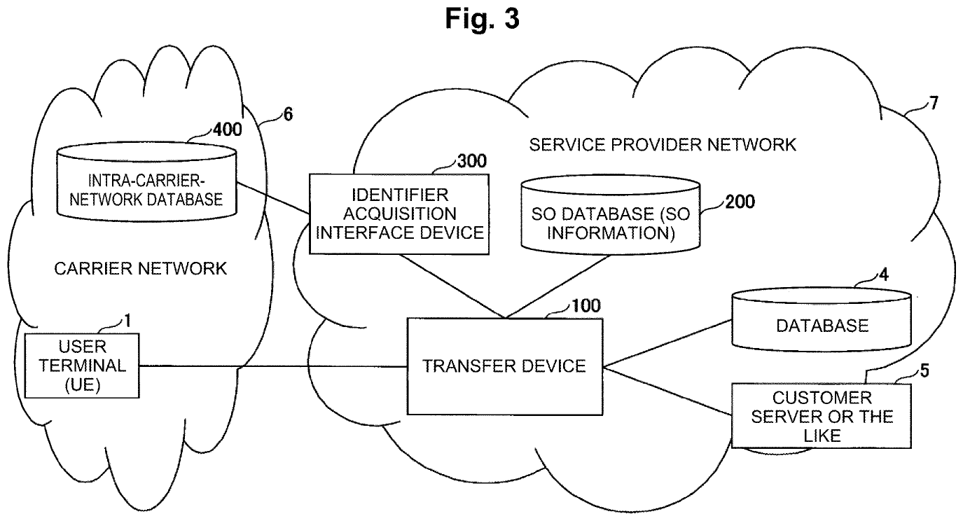

FIG. 3 illustrates the configuration of the system relating to the present embodiment. As illustrated in FIG. 3, the service provider network 7 includes a transfer device 100, an SO database 200, an identifier acquisition interface device 300, a database 4 and a customer server or the like 5. The carrier network 6 includes an intra-carrier-network database 400.

Similarly to the case of FIG. 2, the tunnel by the GTP-U or the like in the carrier network 6 is terminated inside the carrier network 6. Therefore, the transfer device 100 on the service provider network 7 cannot specify the user from just a header of the packet which is sent out from the user terminal 1 and reaches the transfer device 100. Note that the service provider network 7 is an example of a network loosely coupled with the carrier network 6.

The carrier network 6 is, for example, a mobile network of the LTE, 5G or the like or the fixed network of NGN or the like. Functions of individual devices are as follows.

The transfer device 100 receives the packet transmitted from the user terminal 1, acquires the user identifier (for example, IMSI (International Mobile Subscriber Identity) in the mobile network) of the user of the user terminal 1 from the intra-carrier-network database 400 via the identifier acquisition interface device 300 based on a transmission source IP address of the received packet, and acquires SO information (the information of the service that the user subscribes to or the like) from the SO database 200 based on the user identifier. The transfer device 100 executes the processing to the packet according to the service that the user subscribes to. Specifically, the transfer device 100 performs data encryption of the packet, packet transfer to the database 4 and packet transfer to the customer server or the like 5 or the like.

The intra-carrier-network database 400 installed on the carrier network 6 is a database which stores an IP address discharged to the user terminal 1 and the user identifier (the IMSI or the like) in correspondence.

The identifier acquisition interface device 300 receives an inquiry including the transmission source IP address of the packet from the transfer device 100, acquires the user identifier from the intra-carrier-network database 400 using the transmission source IP address, and performs transmission to the transfer device 100. In this way, by interposing the identifier acquisition interface device 300, inter-network connection is easily and flexibly achieved.

As already described, the carrier network 6 is the mobile network of the LTE, the 5G or the like or the fixed network of the NGN or the like.

In the case where the carrier network 6 is the mobile network, the intra-carrier-network database 400 corresponds to a subscriber information management device (such as an HLR (Home Location Register) or an HSS (Home Subscriber Server)) which stores the IP address and the IMSI.

In the case where the carrier network 6 is the fixed network, the intra-carrier-network database 400 corresponds to a database held by a DHCP server which discharges a global IP address.

The identifier acquisition interface device 300 can bear a connection point with one or more different carrier networks. The identifier acquisition interface device 300 is a Rasius server for example. The identifier acquisition interface device 300 may be configured to interact with the plurality of carrier networks by one device, or may be provided for each carrier network to be connected.

Since the intra-carrier-network database 400 is different for each carrier network, a method that the identifier acquisition interface device 300 acquires the user identifier from the intra-carrier-network database 400 is different according to the intra-carrier-network database 400 for each carrier network.

On the other hand, an inquiry method from the transfer device 100 to the identifier acquisition interface device 300 can be unified regardless of the carrier network. Thus, the transfer device 100 can inquire the user identifier without being conscious of a type (such as the fixed network or the mobile network) of the carrier network.

That is, by the technology relating to the present embodiment, in the transfer device 100, an inquiry function to the identifier acquisition interface device 300 does not need to be mounted for each kind of the carrier network. In addition, by the technology relating to the present embodiment, the plurality of different carrier networks can be handled as a group of the same user. For example, by the technology relating to the present embodiment, the same service can be provided in the fixed network and the mobile network.

(Device Configuration)

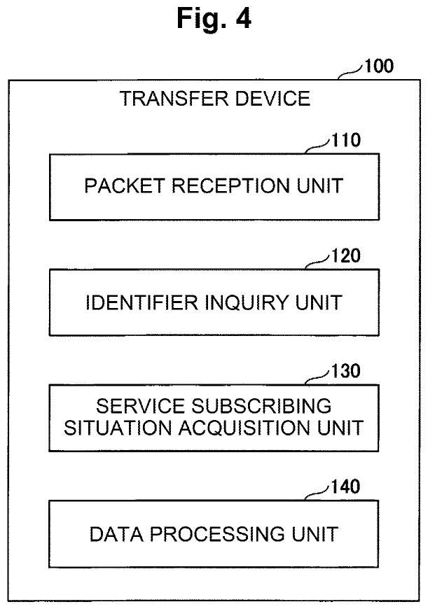

FIG. 4 illustrates a functional configuration of the transfer device 100 in the present embodiment. As illustrated in FIG. 4, the transfer device 100 includes a packet reception unit 110, an identifier inquiry unit 120, a service subscriber situation acquisition unit 130 and a data processing unit 140.

The packet reception unit 110 receives the packet from the user terminal 1. The identifier inquiry unit 120 transmits a user identifier inquiry to the identifier acquisition interface device 300 using the transmission source IP address of the packet, and receives the user identifier from the identifier acquisition interface device 300. The service subscribing situation acquisition unit 130 acquires the information indicating the service subscribing situation of the user (such as the service that the user subscribes to) from the SO database 200 using the user identifier.

The data processing unit 140 performs the data processing according to the service subscribing situation (the subscribing service or the like) of the user corresponding to the received packet.

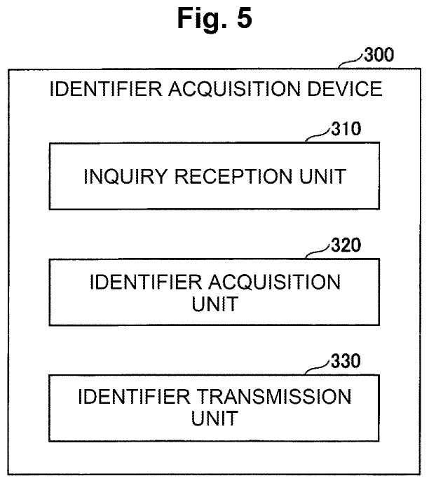

FIG. 5 illustrates the functional configuration of the identifier acquisition interface device 300. As illustrated in FIG. 5, the identifier acquisition interface device 300 includes an inquiry reception unit 310, an identifier acquisition unit 320 and an identifier transmission unit 330.

The inquiry reception unit 310 receives the user identifier inquiry including the transmission source IP address from the transfer device 100. The identifier acquisition unit 320 acquires the user identifier from the intra-carrier-network database 400 using the transmission source IP address. The identifier transmission unit 330 transmits the user identifier acquired by the identifier acquisition unit 320 to the transfer device 100.

Both of the transfer device 100 and the identifier acquisition interface device 300 can be achieved by making a computer execute a program, for example. The computer may be a physical computer or may be a virtual machine.

That is, the device (the transfer device 100 or the identifier acquisition interface device 300) can be achieved by executing the program corresponding to the processing executed in the device using a hardware resource such as a CPU or a memory built in the computer. The program can be recorded in a computer-readable recording medium (such as a portable memory), preserved and distributed. In addition, it is also possible to provide the program via the network of the Internet or electronic mail or the like.

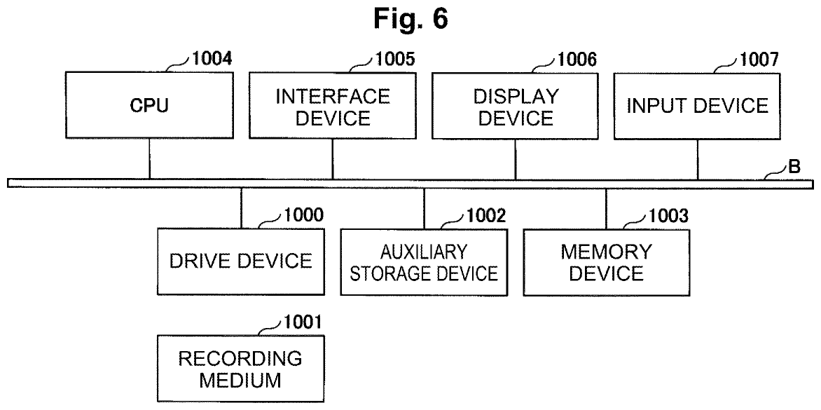

FIG. 6 is a diagram illustrating a hardware configuration example of the computer. The computer in FIG. 6 includes a drive device 1000, an auxiliary storage device 1002, a memory device 1003, a CPU 1004, an interface device 1005, a display device 1006 and an input device 1007 or the like respectively connected to each other via a bus B.

The program which achieves the processing in the computer is provided by a recording medium 1001 such as CD-ROM or a memory card, for example. When the recording medium 1001 storing the program is set to the drive device 1000, the program is installed from the recording medium 1001 to the auxiliary storage device 1002 via the drive device 1000. However, the program does not need to be always installed from the recording medium 1001, and may be downloaded from another computer via the network. The auxiliary storage device 1002 stores the installed program and also stores required files and data or the like.

In the case where activation of the program is instructed, the memory device 1003 reads and stores the program from the auxiliary storage device 1002. The CPU 1004 achieves the function relating to the device according to the program stored in the memory device 1003. The interface device 1005 is used as an interface to be connected to the network and functions as an input means and an output means via the network. The display device 1006 displays a GUI (Graphical User Interface) or the like by the program. The input device 157 is configured by a keyboard and a mouse, buttons or a touch panel or the like, and is used to input various operation instructions.

(Operation Example)

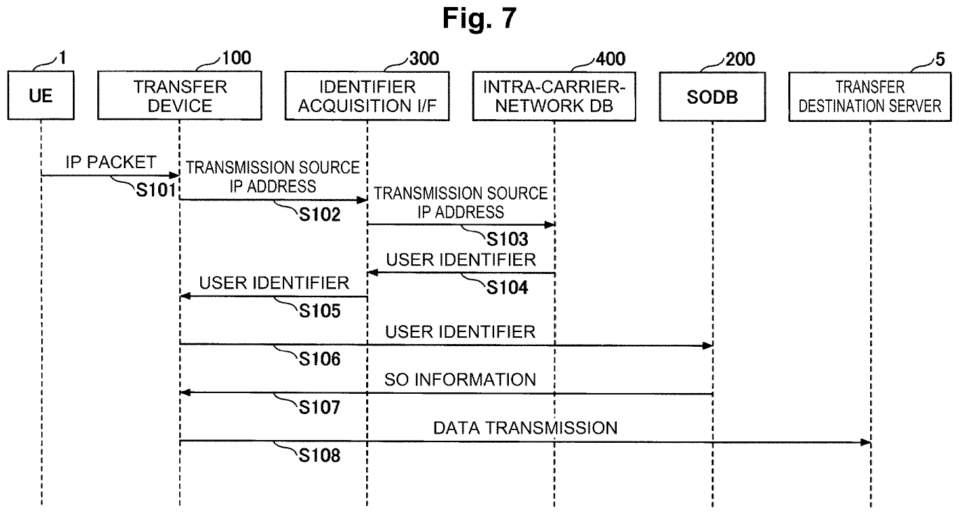

The operation example of the system relating to the present embodiment will be described with reference to a sequence diagram in FIG. 7. As the premise of the processing illustrated in FIG. 7, it is assumed that the IP address is allocated to the user terminal 1 from the carrier network 6, and the IP address is used as the transmission source IP address of an IP packet transmitted from the user terminal 1. In addition, it is assumed that the IP address is stored in the intra-carrier-network database 400 corresponding to the user identifier of the user of the user terminal 1.

In S101, the user terminal 1 transmits the IP packet. The packet reception unit 110 of the transfer device 100 receives the IP packet.

In S102, the identifier inquiry unit 120 of the transfer device 100 transmits a user identifier inquiry signal including the transmission source IP address to the identifier acquisition interface device 300. The inquiry reception unit 310 of the identifier acquisition interface device 300 receives the inquiry signal.

In S103 and S104, the identifier acquisition unit 320 of the identifier acquisition interface device 300 acquires the user identifier corresponding to the transmission source IP address in the intra-carrier-network database 400 from the intra-carrier-network database 400 by transmitting the transmission source IP address to the intra-carrier-network database 400.

In S105, the identifier transmission unit 330 of the identifier acquisition interface device 300 transmits the user identifier acquired by the identifier acquisition unit 320 to the transfer device 100. In the transfer device 100, the identifier inquiry unit 120 receives the user identifier.

In S106 and S107, the service subscribing situation acquisition unit 130 of the transfer device 100 acquires the SO information (the information of the service that the user subscribes to or the like) corresponding to the user identifier in the SO database 200 from the SO database 200 by transmitting the user identifier to the SO database 200.

In S108, the data processing unit 140 of the transfer device 100 transfers the packet (data) to a transfer destination server 5 which is the customer server or the like, for example, based on the SO information of the user.

Note that, in the present embodiment, it is not essential to be provided with the identifier acquisition interface device 300, and the identifier acquisition interface device 300 may not be provided. In that case, the identifier inquiry unit 120 of the transfer device 100 includes a function of acquiring the user identifier from the intra-carrier-network database 400 based on the transmission source IP address similarly to the identifier acquisition interface device 300.

In addition, it is also not essential to inquire the SO database 200 (acquire the SO information) after the transfer device 100 acquires the user identifier. That is, the data processing unit 140 of the transfer device 100 may perform the data processing corresponding to the user identifier without inquiring the SO database 200 in the case where data processing contents can be identified directly from the user identifier.

(Effects of Embodiment)

As described above, in the present embodiment, in a transfer device deployed in a network (service provider network) loosely coupled with a carrier network, a user identifier (for example, IMSI in a mobile network) is acquired from a database installed in the carrier network based on a transmission source IP address of a packet when the packet is received, SO information is acquired based on the identifier, and service provision for each user is achieved. In addition, an interface device for inquiry installed within the service provider network is interposed for the inquiry to the database of the carrier network so that inter-network connection is easily and flexibly achieved.

As described above, even in the case where the transfer device is deployed in the network loosely coupled with the carrier network, the service provision for each user is made possible. Further, since the IP address discharged to the user terminal 1 and the SO information can be linked, the service provision for each user is possible even in the case where the IP address discharged to the user terminal changes.

(Summary of Embodiment)

The present description discloses at least a transfer device, a data processing method and a program of individual clauses below.

(Clause 1)

A transfer device provided on a service provider network different from a carrier network, the transfer device including:

an identifier inquiry unit configured to acquire a user identifier from an intra-carrier-network database storing an IP address and the user identifier using a transmission source IP address of a packet received from a user terminal to which the IP address is allocated from the carrier network; and

a data processing unit configured to execute processing to the packet according to the user identifier.

(Clause 2)

The transfer device according to Clause 1,

wherein the identifier inquiry unit transmits an identifier inquiry including the transmission source IP address to an identifier acquisition interface device provided on the service provider network, and receives the user identifier acquired from the intra-carrier-network database by the identifier acquisition interface device from the identifier acquisition interface device.

(Clause 3)

The transfer device according to Clause 1 or 2,

wherein the data processing unit acquires information of a service that a user corresponding to the user identifier subscribes to from a database storing the information of the service by transmitting the user identifier to the database, and executes processing corresponding to the service.

(Clause 4)

A data processing method executed by a transfer device provided on a service provider network different from a carrier network, the method comprising:

an identifier inquiry step of acquiring a user identifier from an intra-carrier-network database storing an IP address and the user identifier using a transmission source IP address of a packet received from a user terminal to which the IP address is allocated from the carrier network; and

a data processing step of executing processing to the packet according to the user identifier.

(Clause 5)

A program for making a computer function as individual units in the transfer device according to any one of Clauses 1 to 3.

The present embodiment has been described above, however, the present invention is not limited to the specific embodiment, and various modifications and changes are possible within a scope of the gist of the present invention described in the scope of claims.

### REFERENCE SIGNS LIST

1 User terminal
2, 100 Transfer device
3, 200 SO database
4 Database
5 Customer server or the like
6 Carrier network
7 Service provider network
300 identifier acquisition interface device
400 Intra-carrier-network database
110 Packet reception unit
120 identifier inquiry unit
130 Service subscriber situation acquisition unit
140 Data processing unit
310 inquiry reception unit
320 identifier acquisition unit
330 identifier transmission unit
1000 Drive device
1001 Recording medium
1002 Auxiliary storage device
1003 Memory device
1004 CPU
1005 Interface device
1006 Display device
1007 Input device

1. A transfer apparatus provided on a service provider network different from a carrier network, the transfer apparatus comprising:
a processor; and
a memory storing program instructions that cause the processor to:
acquire a user identifier from an intra-carrier-network database storing an IP address and the user identifier using a transmission source IP address of a packet received from a user terminal to which the IP address is allocated from the carrier network; and
execute processing to the packet according to the user identifier.

2. The transfer apparatus according to claim 1,
wherein the program instructions further cause the processor to transmit an identifier inquiry including the transmission source IP address to an identifier acquisition interface device provided on the service provider network, and receives the user identifier acquired from the intra-carrier-network database by the identifier acquisition interface device from the identifier acquisition interface device.

3. The transfer apparatus according to claim 1,
wherein the program instructions further cause the processor to acquire information of a service that a user corresponding to the user identifier subscribes to from a database storing the information of the service by transmitting the user identifier to the database, and executes processing corresponding to the service.

4. A data processing method executed by a transfer apparatus provided on a service provider network different from a carrier network, the method comprising:
acquiring a user identifier from an intra-carrier-network database storing an IP address and the user identifier using a transmission source IP address of a packet received from a user terminal to which the IP address is allocated from the carrier network; and
executing processing to the packet according to the user identifier.

5. A non-transitory computer-readable storage medium that stores therein a program for making a computer including a memory and a processor to operate as the transfer apparatus according to claim 1.
